(19) United States
(12) Patent Application Publication
(10) Pub. No.: US 2013/0162655 A1
(43) Pub. Date: Jun. 27, 2013

(54) Systems and Methods for Creating, Displaying, and Using Hierarchical Objects with Nested Components

(71) Applicant: Eric J. Mueller, Freemont, CA (US)

(72) Inventor: Eric J. Mueller, Freemont, CA (US)

(73) Assignee: Adobe Systems Incorporated, San Jose, CA (US)

(21) Appl. No.: 12/197,684

(22) Filed: Aug. 25, 2008

(51) Int. Cl. G06T 15/70

(52) U.S. Cl. 345/474

(57) ABSTRACT

Methods involving the creation and use of nested components with hierarchical objects are disclosed. One exemplary method comprises displaying a container symbol and defining a movement for the container symbol. The method further comprises defining a nested object within the container symbol, i.e. on a coordinate space associated with the container symbol rather than the general canvas area, and defining a movement for the nested object. Either or both of the movements may involve an inverse kinematics procedure based movement of a hierarchical object, e.g., movement of a bone that causes a shape or rigid body to move. For example, a container symbol could display a car and include a nested hierarchical object that is used to define a person within the car. The movement of the car and the movement of the person can be defined separately by a developer.

### FIELD

Embodiments relate generally to the field of computing and specifically to computing applications used to create, control, and otherwise display objects.

### BACKGROUND

Media often involves the display of animated or moving objects. For example, a media object may consist of a series of frames played one after another by a media player. The sequential playing of the frames gives the appearance of objects within the frames moving over time. Development of such media can involve painstakingly creating each object in each frame independently. For example, animating a car moving down a street may involve redrawing the street and the car in a different position on the street in each of a series of multiple frames. Certain techniques exist to help developers simplify this otherwise painstaking and repetitive process. Some development tools allow a developer to reuse elements of a previous frame in a subsequent frame. For example, a developer may need to draw the street and the car only once to create the frames of the previous example. After drawing the street and the car for a first frame, the developer can save these objects in a first frame and then use them as a basis for created subsequent frames. A development tool may, for example, allow the developer to simply reposition the car object and save the second frame, reposition the car again and save the third frame, etc. Another technique that can simplify the process of creating animation involves extrapolating between frames created by a developer. In the previous example, a developer may create a first frame with the car at one end of a street and a second frame with the car at a second end of the street. The development tool can use the first and second frames as end points to create additional frames for inclusion in the play sequence of frames. For example, the positions of the car in the end frames can be used to determine several intermediate positions of the car on the street for intermediate frames.

In spite of these and other powerful features, present authoring and media environments could improve with respect to facilitating the movement of more complicated objects. In particular, moving objects that have multiple, interrelated parts continue to present various challenges. One example, is the complexity involved in animating a person or figure waving his or her hand or picking up an object on the ground. The more complex the figure (i.e., the more parts it has), the more difficult this task is for the developer. In many cases, the developer will be required to redraw (or reposition) each component of the object, e.g., the hand, the forearm, the upper arm, the shoulder, the head, etc.

The movement of multi-part and other complicated objects has been facilitated by defining an object as a “hierarchical object.” A “hierarchical object” is any object having at least some components to which a parent-child order has been ascribed (i.e., a first component is the parent of a second component, which is the parent of a third component, etc.). Just as a human figure/body is comprised of a plurality of bones, each bone being interconnected, and having a relationship with the adjacent bones, a hierarchical object can be considered to comprise a plurality of components that are also called “bones.” In one aspect a bone may be visualized as a straight line, or alternatively the bone may be visualized or displayed as a shape. Each of these bones has a base point and a tip point, approximately at each end of the bone, respectively. For example, where a first bone is the parent of a second bone, the tip of the first bone may be “attached” to the base of the second bone. This “attachment” can be used by a development tool to coordinate movement of the object, i.e., when one bone moves the other bone will move to preserve the attachment.

In addition to bones, hierarchical objects may also comprise linked components that are linked (with respect to movement) to the bones of the hierarchy. For example, an outer shape or mesh may be defined based on the position of one or more of the bones. As a specific example, an outer shape may be drawn by a developer and include various control points on the shape. When a bone is moved, any control points associated with the moved bone will cause the shape to move and/or deform. In the case of the person figure example described above, some development tools have allowed a developer to draw, for example, outline shapes of a hand, forearm, upper arm, shoulder, and the rest of the desired display components of a figure. The developer could then draw and associate a hierarchy of bones with these display components, so that movement of the hand outline shape causes the associated bone hierarchy to move, which then causes the other outline shapes to also move. For example, a single action by a developer moving the hand outline to a new position could automatically result in the repositioning of many (or all) of the other outlined components of the figure object, e.g., the forearm, upper arm, shoulder, hand, etc.

The use of hierarchical objects has been facilitated and/or enhanced with the use of kinematics techniques. For example, inverse kinematics have been used to reposition the bones of a hierarchical object based on a single movement created by a developer. Some development tools implement the kinematics techniques as algorithms executed behind the scenes, i.e., without direct user input or knowledge. Despite the advantages and benefits of using hierarchical object and kinematics techniques in the context of animating objects, many aspects of animation in computer-based media development continue to require significant user interaction. For example, while existing tools allow the creation of nested movement (i.e., movement of an object within another moving object), such nesting is not adequately facilitated for hierarchical objects.

### SUMMARY

Methods involving the creation and use of hierarchical objects are disclosed. For example, certain embodiments facilitate the creation, display, and/or editing of nested hierarchical object components. In one embodiment, a computer implemented method comprises displaying a canvas area comprising a first coordinate space in a media content development environment. The method further comprises outputting a container symbol for display on the canvas area. A “container symbol” is any object that contains one or more other objects. Examples include, but are not limited to, a rigid body, a graphic, a button, and a representation for a movie clip. In this exemplary method, the container symbol comprises a second coordinate space. The method further comprises outputting a hierarchical object for display at least partially on the container symbol and receiving a movement for the container symbol with respect to the first coordinate space. The movement of the container symbol also effectively moves the second coordinate space that is associated with the container symbol. The method further comprises receiving a movement for the hierarchical object with respect to the second coordinate space, the movement comprising a rotation of a bone determined using an inverse kinematics procedure identifying an amount of rotation of the bone about the base of the bone.

Certain other exemplary embodiments relate to a computer-implemented method that comprises outputting an animation for display as part of a piece of media content. The animation comprises a first movement of an object defined by a movement of a container symbol on a coordinate space of a canvas area. The animation also comprises a second movement of the object defined by a movement of a nested component on a coordinate space associated with the container symbol. One or both of these movements may be determined by a rotation of a bone determined using an inverse kinematics procedure identifying an amount of rotation of the bone about a base of the bone. The movements may occur simultaneously or otherwise overlap one another.

In other embodiments, a computer-readable medium (such as, for example, random access memory or a computer disk) comprises code for carrying out the methods described herein.

These illustrative embodiments are mentioned not to limit or define the invention, but to provide examples to aid understanding thereof Illustrative embodiments are discussed in the Detailed Description, and further description of the disclosure is provided there. Advantages offered by various embodiments of this disclosure may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 is a system diagram illustrating a media content authoring environment and an exemplary runtime environment according to certain embodiments;

FIGS. 2a-m provide an example of a moving object and a user interface for creating and displaying the movement of the object, according to certain embodiments;

FIG. 3 is a flow chart illustrating a method of displaying a hierarchical object with nested components, according to certain embodiments; and

FIG. 4 is a flow chart illustrating another method of displaying a hierarchical object with nested components, according to certain embodiments.

### DETAILED DESCRIPTION OF EXEMPLARY EMBODIMENTS

Methods involving the creation and use of nested components with hierarchical objects are disclosed. One exemplary method comprises displaying a container symbol and defining a movement for the container symbol. The method further comprises defining a nested object within the container symbol, i.e. on a coordinate space associated with the container symbol rather than the general canvas area, and defining a movement for the nested object. Either or both of the movements may involve an inverse kinematics procedure based movement of a hierarchical object, e.g., movement of a bone that causes a shape, rigid body, or other component object to move. For example, a container symbol could display a car and include a nested hierarchical object that is used to define a person within the car. The movement of the car and the movement of the person can be defined separately by a developer.

### Illustration of Development of a Hierarchical Object with Nested Components

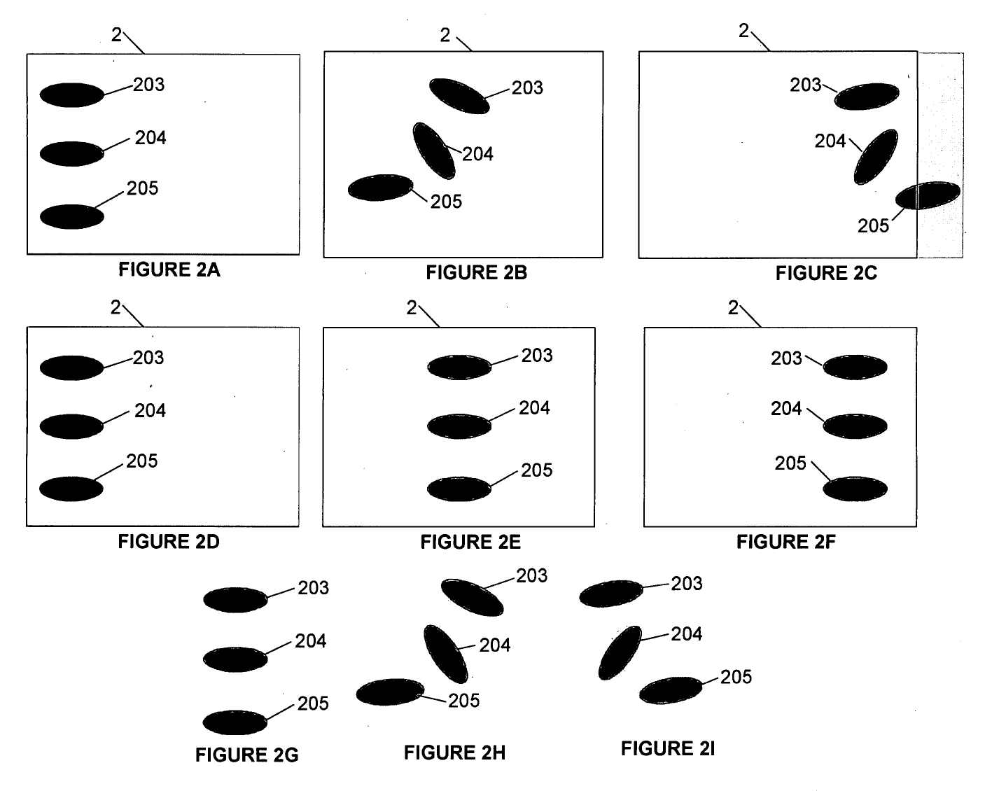

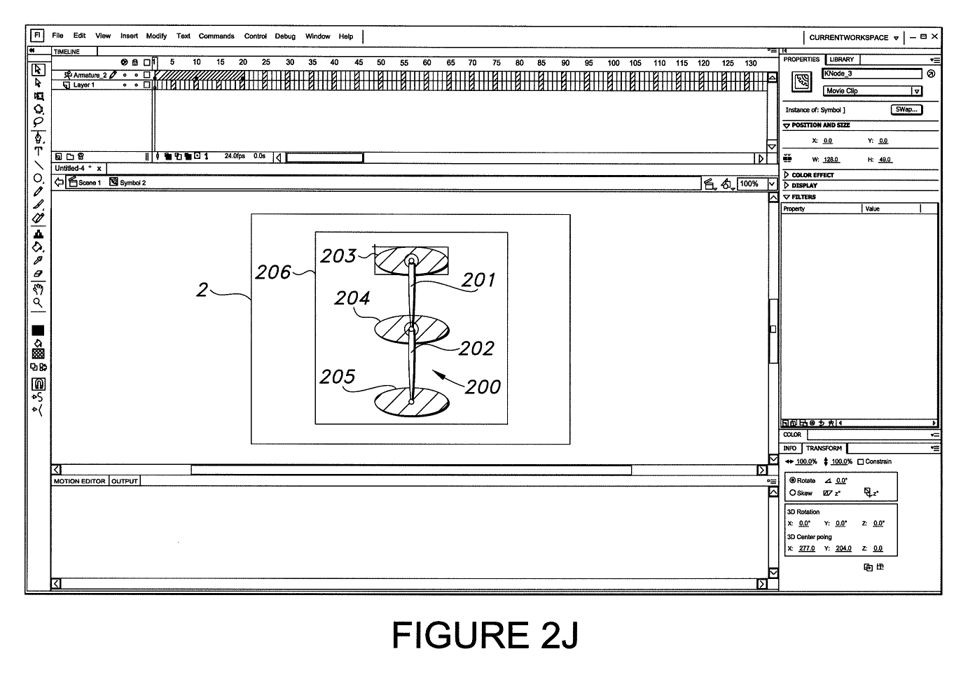

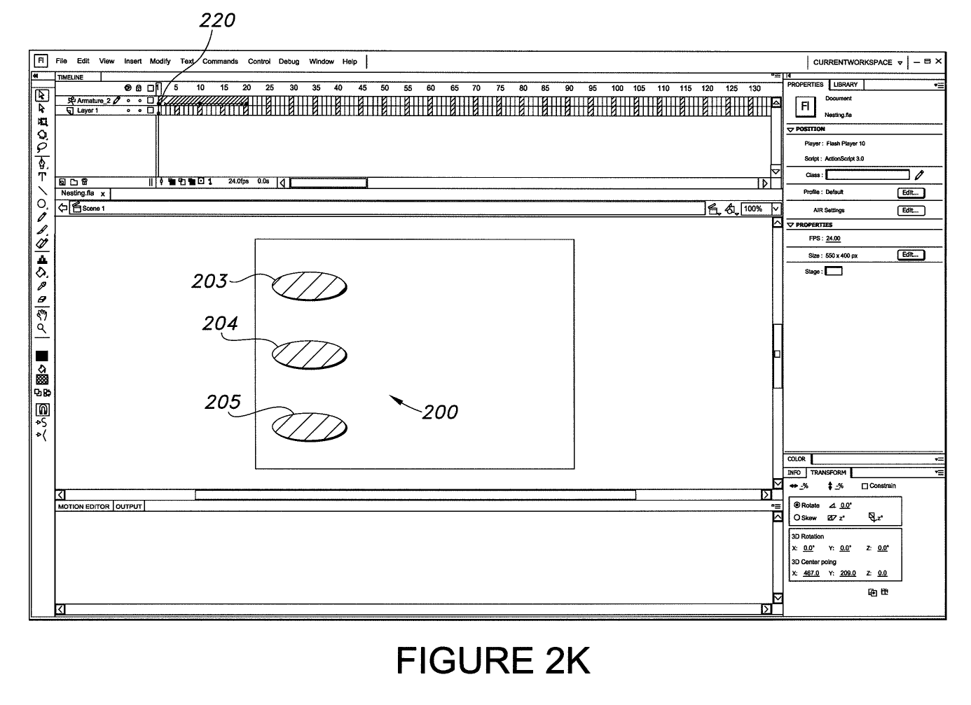

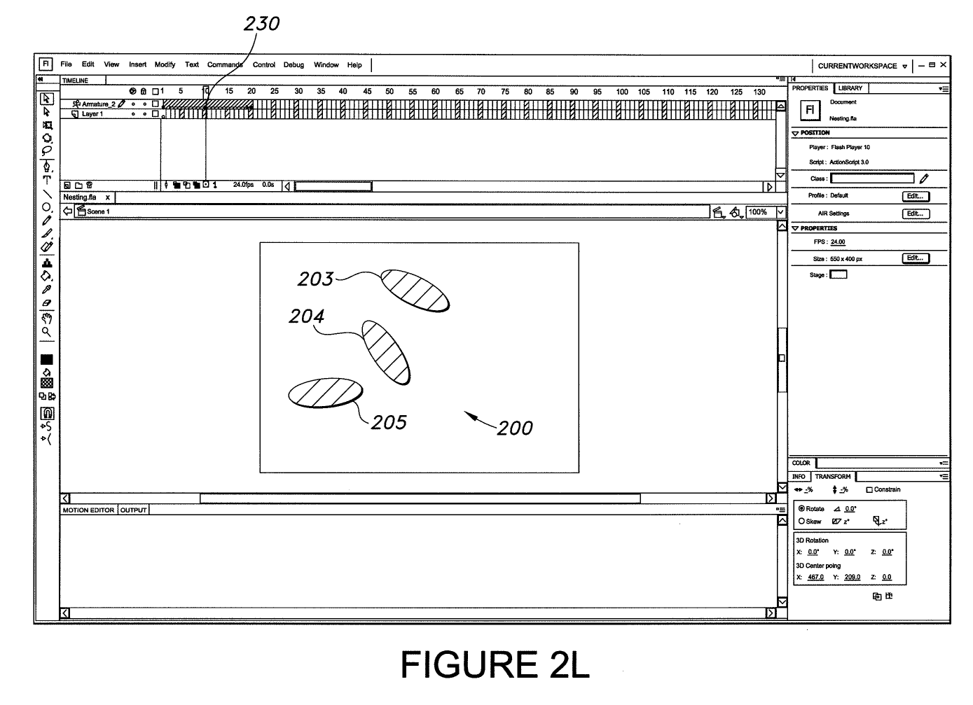

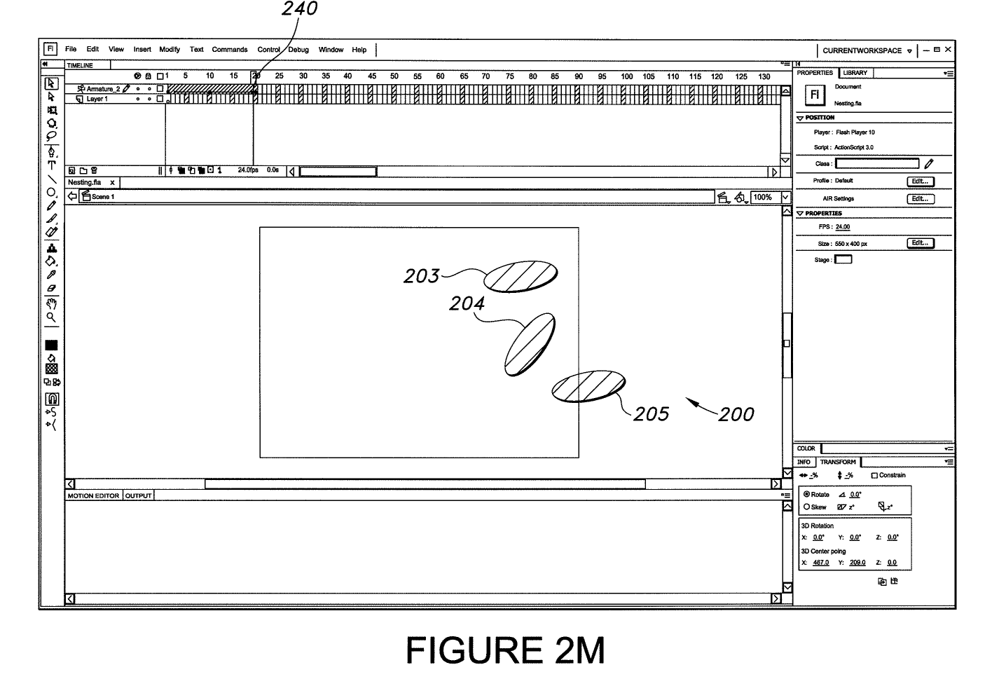

The following specific illustrative embodiment is provided to illustrate some of the applications, uses, and benefits of certain of the techniques described herein. Referring now to the drawings in which like numerals indicate like elements throughout the several figures, FIGS. 2a-c provide an example of the animation of several related objects 203, 204, 205 moving on a canvas 2. The movement of the objects 203, 204, 205 from their positions in FIG. 2a to their positions in FIG. 2b to their positions in FIG. 2c may appear continuous to an observer viewing the animated media content with the objects occupying various intermediate positions over the time period of the animation during which the movement occurs.

The movement of the objects 203, 204, 205 can be considered as two distinct movements. The first movement, shown in FIGS. 2d, 2e, and 2f, is a simple left to right movement in which each of the three objects moves together from left to right. The second movement, shown in FIGS. 2g, 2h, and 2i, is a movement that was defined using one or more inverse kinematics procedures operating on a hierarchical object that comprises the three moving objects 203, 204, 205. In this example, the three objects 203, 204, 205 are rigid bodies that are each associated with one or more bones of a single hierarchical object. Techniques for using inverse kinematics with rigid body components are described in U.S. Patent Application entitled “SYSTEMS AND METHODS FOR CREATING, DISPLAYING, AND USING HIERARCHICAL OBJECTS WITH RIGID BODIES,” filed concurrently herewith, and incorporated herein in its entirety by this reference.

Allowing movement to be defined as the combination of multiple movements facilitates the creation of complicated movements. Embodiment of the present disclosure thus may facilitate the creation of complicated and sophisticated animations and other movements, including those in which one or more component movements involves movement defined using inverse kinematics procedures.

FIGS. 2j-2m illustrate an exemplary user interface for creating the movements illustrated in FIGS. 2a-i. FIG. 2j illustrates an interface that allows a developer to create a container symbol 206 on the canvas area 2. The container symbol 206 is defined and positioned within a coordinate space associated with the canvas 2. In this example, the container symbol is a rectangle that will not have any attributes that are actually displayed in the resulting animation, i.e., the fill will be empty and the sides will not be visible. The sides are displayed here to aid in development and for illustrative purposes. The container symbol 206 has a coordinate space, which in this case is shown as the area within the perimeter of container symbol.

The developer can define a hierarchical object 200 within the coordinate space of the container symbol 206. Thus the 200 hierarchical object will move with the container symbol in addition to moving as it might be defined to do relative to the container symbol's coordinate space. As a specific example, a container symbol could be a car shape and a hierarchical object could be positioned within the car and used to animate a person displayed within the car. As a specific example, the hierarchical object could be used to wave the person's hand back and forth with respect to the coordinate space of the car. If the car is also moved, the person (including his/her hand) will move with the car, with the hand's additional waving movement defined relative to the car's coordinate space.

A developer may use the user interface of FIG. 2j to the hierarchical object by creating bones 201, 202 and rigid bodies 203, 204, 205 within the coordinate space of the container symbol 206. This coordinate space may be displayed on top of the canvas 2 displayed on a interface user on a computer screen in a media content authoring environment. A developer may have first placed a root bone 201, by identifying a location for a bone base and a bone tip, and then placed another bone 202 to be a child of the root bone in the hierarchical object by identifying a location of a bone base at (or near) the tip of the root bone 201 and a bone tip for the child bone 202. The developer may then create the rigid bodies 203, 204, 205, for example, by drawing perimeters for each of the rigid bodies 203, 204, 205. Generally, a rigid body may or may not be associated with a hierarchical object. Association with a hierarchical object may be assumed when a rigid body is drawn to include an area of the coordinate space that includes one or more of the bone tips and/or bases. Alternatively, the association may be manually made by the developer, for example if a developer wishes to associate a rigid body that does not include a bone base or tip. In FIG. 2j, the first rigid body 203 is drawn to include the root bone 201 base. The second rigid body 204 is drawn to include the root bone 201 tip and the child bone 202 base. The third rigid body 205 is drawn to include the child bone 202 tip.

The terms “rigid body” and “rigid bodies” refer to any object that can be associated with a hierarchical object to move (rotate and/or translate) when one or more of the bones of the hierarchical object moves. A rigid body is “rigid” in the sense that its shape, i.e. its perimeter (or outer surface in the case of a three dimensional rigid body), does not change with the movement of the hierarchical object. For example, a circle remains a circle with the same diameter and a rectangle remains a rectangle with the same width and length as these objects rotate and/or translate based on the movement of the bones of the hierarchical object. The container symbol 206 may be a rigid body.

Both the container symbol 206 and the hierarchical object 200 can be moved by the developer with such movements associated with different timelines. Thus, a developer can define a movement for the container symbol 206 on a first timeline, e.g., at a first time on the timeline the container symbol 206 is at a position on the left side of the canvas 2 coordinate space and at second time on the timeline the container symbol 206 may be positioned on the right side of the canvas 2. These snapshots can be used to display movement, for example by extrapolating a series of intermediate positions for the container symbol 206 for the time segments between the first time and the second time.

Similarly, a developer can define movements for the hierarchical component 200 by positioning the hierarchical object components in differing positions (on the container symbol 206 coordinate space) and associating the different positions with points on a separate timeline. When the media content is created the movement timelines may be triggered and occur simultaneously so that the movement of the hierarchical object 200 components (e.g., the rigid bodies 203, 204, 205) is displayed as a combination of the two defined movements. The different positions for the hierarchical object components can be created by the developer with support from inverse kinematics procedures. For example, the developer may create a movement for the hierarchical object 200 by selecting an end effector location on a rigid body and then selecting a target location. The media content development environment receives these end effector and target location selections and repositions the components of the hierarchical object. For example, the bones 201 and 202 may be rotated using inverse kinematics procedures that attempt to position the end effector nearer to the target location. The positions of the rigid bodies 203, 204, 205 may be determined based on the changed positions of the bones 201, 202.

FIG. 2k illustrates the positions of the rigid bodies 203, 204, 205 of the hierarchical object 200 when the container symbol (not shown) is positioned towards the left side of the canvas 2. On a first timeline, this position of the container symbol can be associated with a first point 220. The initial positions of the rigid bodies 203, 204, 205 on the coordinate space of the container symbol can be associated with a first point on a second timeline (not shown).

FIG. 2l illustrates the positions of the rigid bodies 203, 204, 205 of the hierarchical object 200 with the container symbol (not shown) positioned towards the center of the canvas 2 and with the positions of the rigid bodies 203, 204, 205 moved according to a first inverse kinematics based movement—here a point on rigid body 205 was selected as an end effector and a target location was selected out to the left of the hierarchical object's prior position. The position of the container symbol can be associated with a second point 230 on the first timeline and the position of the rigid bodies on the coordinate space of the container symbol can be associated with a second point on the second timeline (not shown).

FIG. 2m illustrates the positions of the rigid bodies 203, 204, 205 of the hierarchical object 200 with the container symbol (not shown) positioned towards the center of the canvas 2 and with the positions of the rigid bodies 203, 204, 205 moved according to another inverse kinematics based movement—here a point on bone 205 was selected as an end effector and a target location was selected out to the right of the hierarchical object's prior position. The position of the container symbol can be associated with a third point 240 on the first timeline and the position of the rigid bodies 203, 204, 205 on the coordinate space of the container symbol can be associated with a third point on the second timeline (not shown).

When the timelines are later used to create media content, the application may extrapolate positions for the starting and ending locations associated with each of the timeline snapshot points. For more precise control of the movement, a developer can simply place additional snapshots in the timeline or otherwise reduce the time between snapshots, among other things.

The movement of the hierarchical object may be determined in other ways. For example, moving the mouse cursor may have generated a stream of target locations that could be used to iteratively move the hierarchical object, allowing the developer to see the changes to the hierarchical object as the mouse is dragged. For each new target location of the stream of target locations, an appropriate movement of the hierarchical object is determined and displayed. The movement may comprise either a rotation, e.g., a rotation of a bone determined by an inverse kinematics procedure, a translation, or both a rotation and a translation of one or more bones of the hierarchical object.

The amount of rotation and or translation of hierarchical object components may be constrained in various ways, e.g., with angular limitations, positional limitations, limitations with respect to only translating in a certain direction, etc. In certain cases, these constraints may prevent an end effector from being moved to a target location, however, rotational and translational movements may be determined and displayed to position the end effector nearer to the target location. Thus, positioning the end effector nearer to the target location may comprise positioning it as close to the target location as possible and in some cases positioning it at the target location.

These illustrative examples are given to introduce the reader to the general subject matter discussed herein and are not intended to limit the scope of the disclosed concepts. The following sections describe various additional embodiments and examples of methods and systems for monitoring content consumption.

### Illustrative Authoring and Runtime Environments

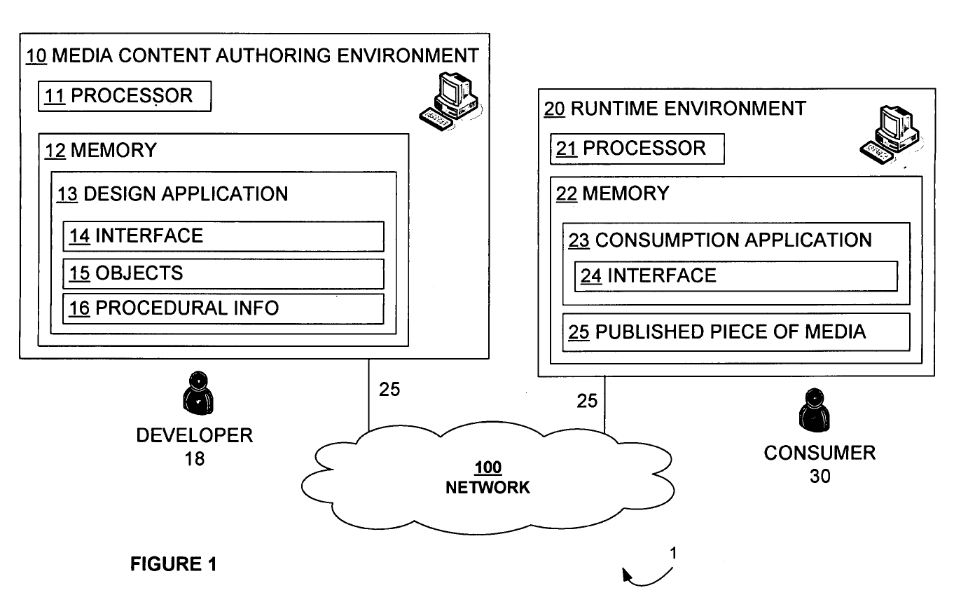

FIG. 1 is a system diagram illustrating a media content authoring environment 10 and an exemplary runtime environment 20 according to certain embodiments. Other embodiments may be utilized. The system 1 shown in FIG. 1 comprises a media content authoring environment 10, which may, for example, include a computing device that comprises a processor 11 and a memory 12. A developer 18 uses the media content authoring environment 10 to author media content. The memory 12 may comprise a design application 13 with an interface 14 that the developer 18 uses for such authoring. The interface 14 may provide a graphical design area or canvas area upon which the developer 18 may place, position, and otherwise define objects that will be a part of a piece of media that is being developed. Information about such objects may be stored in memory 12.

The design application 13 may allow the developer 18 to create and use hierarchical objects, for example, by allowing the developer 18 to position components on a graphical design area and create and revise relationships between components of a hierarchical object.

The design application 13 may further allow the developer 18 to perform procedures on objects of the piece of media being developed, including performing kinematics procedures. Thus, a developer 18 may specify a two bone hierarchical object and then specify end effector and target locations for a kinematics-based movement. The design application 12 comprises procedural information 16 for carrying out these kinematics and other procedures within the design application 13, for example, by displaying the movement on a graphical design area.

Once the developer is ready to publish a piece of media to a runtime environment, the design application 13 generates a piece of media 25. The piece of media 25 may be used by another application on the developer's computing device or sent to another location, for example, through a network 100 to a runtime environment 20. The runtime environment may also include a processor 21 and a memory 22. The memory 22 will generally include a consumption application 23 that provides an interface 24 for viewing or otherwise consuming pieces of media. The piece of media 25 may be stored in memory 22 and viewed or otherwise consumed by a consumer 30 using the interface 24 of the consumption application 23.

### Illustrative Method of Displaying a Hierarchical Object with Nested Components

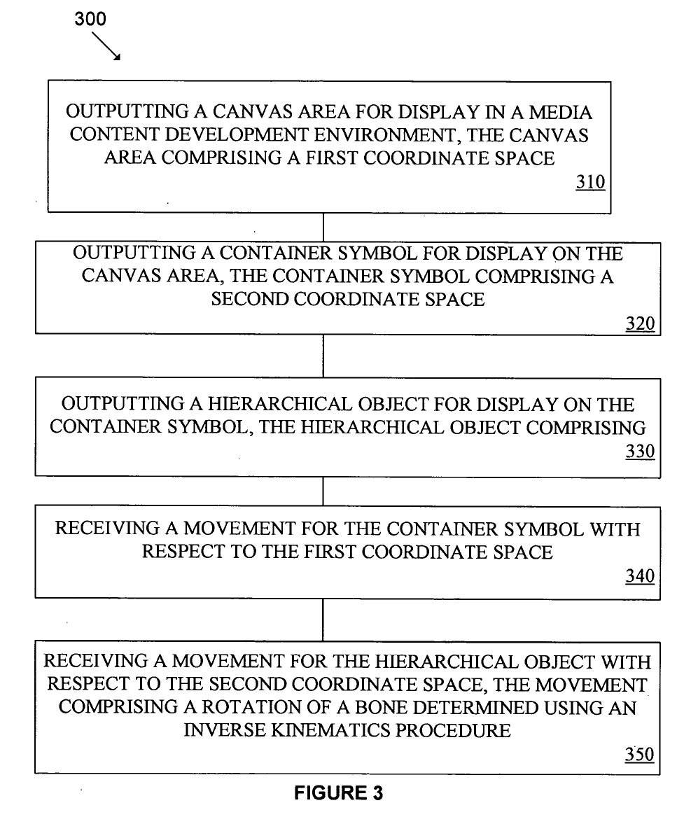

FIG. 3 is a flow chart illustrating a method of displaying a hierarchical object with nested components, according to certain embodiments. For purposes of illustration only, the elements of this method 300 may be described with reference to the system depicted in FIG. 1. A variety of other implementations are also possible.

The method 300 may be computer-implemented. The method 300 comprises outputting a canvas area for display in a media content development environment, the canvas area comprising a first coordinate space, as shown in block 310. The canvas area may be a region of a computer displayed interface in which a developer can position and manipulate objects to be included in a piece of media content.

The method 300 further comprises outputting a container symbol for display on the canvas area, the container symbol comprising a second coordinate space, as shown in block 320. A container symbol can itself be a rigid body, a movie clip, a button, a graphic, and/or any other object usable in a piece of media.

The method 300 further comprises outputting a hierarchical object for display on the container symbol, the hierarchical object comprising: a plurality of bones, each bone comprising a base and a tip, as shown in block 330. This may involve receiving information about component objects and one or more relationships between the component objects of the hierarchical object. These component objects may, as examples, comprise one or more bones, shapes, and/or rigid bodies. For example, the hierarchical object may comprise bones and a rigid body with a base of a bone positioned within the rigid body. Information about component objects may also be specified, including, as examples, information connecting bones to one another in a hierarchical scheme and that link or otherwise associate one or more rigid bodies with one or more of the bones. The hierarchical object may also be associated with constraint information (e.g., angular limits, translation limits), and/or any other relevant information. A constraint may limit the translation and/or rotation of a bone of a hierarchical object, among other things. In certain embodiments, the position of a rigid body is defined by a matrix, for example, a set of numbers that uniquely identifies the position (location and/or orientation) of a rigid body on a canvas.

Receiving and/or displaying a hierarchical object can involve a system such as the system illustrated in FIG. 1. As one example, the media content authoring environment 10 could receive in the interface 14 of a design application 13 one or more inputs from a developer 18 specifying the location of two related bones: a parent bone connected to a child bone. The interface 14 may also receive, for example, a constraint from the developer 18 specifying that the angle between the bones shall not be less than 45 degrees. As another example, the developer 18 may further specify that a rigid body will be positioned surrounding the intersection of the two bones by drawing a shape around that intersection.

Referring again to FIG. 3, the method 300 further comprises receiving a movement for the container symbol with respect to the first coordinate space, as shown in block 340. The movement of the container symbol moves the second coordinate space that is associated with the container symbol.

The method 300 further comprises receiving a movement for the hierarchical object with respect to the second coordinate space, as shown in block 350. The movement may be based upon a rotation of a bone determined using an inverse kinematics procedure identifying an amount of rotation of the bone about the base of the bone. Receiving the movement may comprise receiving identification of an end effector and a target location, for example selected using a selection device such as a mouse. The identifications of the end effector and/or target location could be specified by a script, a developer, or in any other manner. The method 300 may comprise receiving a stream of target locations based on a moving position of a cursor on the canvas area. For each target location of the stream of target locations, a movement of the bone and a movement of the rigid body are determined and displayed.

Thus, receiving the movement for the hierarchical object with respect to the second coordinate space may comprise receiving an identification of an end effector on the hierarchical object and receiving an identification of a target location as a point of the second coordinate space. It may further comprise determining a changed position of a bone comprising a rotation determined using an inverse kinematics procedure identifying an amount of rotation of the bone about the base of the bone. The inverse kinematics procedure may attempt to position the end effector nearer to or at the target location.

The method 300 may further comprise causing the container symbol and the hierarchical object to move on the display. Such movement may occur simultaneously. An animation may be created for a piece of media based on various positions of the container symbol and the movement for the hierarchical object. Such animation may comprise a time period over which the animation will be displayed by the piece of media content. For example, the animation may comprise a first snapshot associated with a point during the time period, the first snapshot comprising any displayed objects (e.g., the rigid body components of the hierarchical object) in positions determined based on the positions of the container symbol and the hierarchical object prior to their respective movements and a second snapshot associated with another point during the time period, the second snapshot comprising the displayed objects in positions determined based on the positions of the container symbol and the hierarchical object after their respective movements. Each of the movements (i.e., of the container symbol and the hierarchical object) may or may not have its own timeline. Such timelines are generally defined to occur within the time period of the animation, for example upon the occurrence of some triggering event or action. The timelines may overlap by developer design or may overlap as a result of user action or other runtime determined event.

### Illustrative Method of Providing Media Content Created Using Nested Components

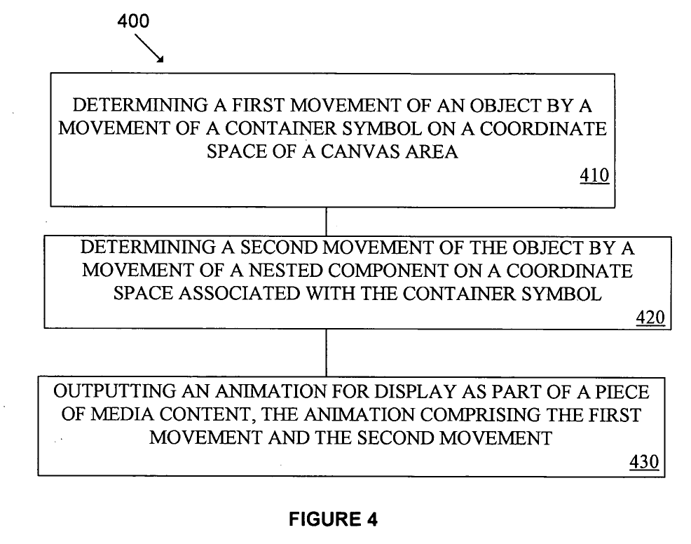

FIG. 4 is a flow chart illustrating another method of displaying a hierarchical object with nested components, according to certain embodiments. For purposes of illustration only, the elements of this method 400 may be described with reference to the system depicted in FIG. 1. A variety of other implementations are also possible.

The method 400 may be computer-implemented such as in the media content authoring environment 10 of FIG. 1. The method 400 comprises determining a first movement of an object based on a movement of a container symbol on a coordinate space of a canvas area of a media content authoring environment, as shown in block 410.

The method 400 further comprises determining a second movement of the object based on a movement of a nested component on a coordinate space associated with the container symbol, as shown in block 420. This may involve receiving information about component objects and one or more relationships between the component objects of the hierarchical object. These component objects may be nested within the container symbol and thus displayed on and interacted with on the coordinate space of the container symbol. These component objects, as examples, may comprise one or more bones, shapes, and/or rigid bodies.

The method 400 further comprises outputting an animation for display as part of a piece of media content, the animation comprising the first movement and the second movement, as shown in block 430. The first movement of the object and the second movement of the object may occur simultaneously in the animation, for example, by occurring during overlapping or partially overlapping time periods. The container symbol, bones, and other components used to create the animation and define its movements may or may not actually be displayed in the animation. For example, in some cases only the rigid bodies and/or shapes will be displayed.

Certain embodiments of the present disclosure comprise outputting an animation for display as part of a piece of media content, the animation comprising a first movement of an object and a second movement of the object; the first movement of the object defined by a movement of a container symbol on a coordinate space of a canvas area, the second movement of the object defined by a movement of a nested component on a coordinate space associated with the container symbol. The first movement of the object and/or the second movement of the object may be determined by a rotation of a bone determined using an inverse kinematics procedure.

### General

Certain embodiments relate to inverse kinematics. These are merely illustrative. In short, the techniques and the other features described herein have uses in a variety of contexts, not to be limited by the specific illustrations provided herein. It should also be noted that embodiments may comprise systems having different architecture and information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

In addition, with respect to the computer implementations depicted in the Figures and described herein, certain details, known to those of skill in the art have been omitted. For example, software tools and applications that execute on each of the devices and functions performed thereon are shown in FIG. 1 as functional or storage components on the respective devices. As is known to one of skill in the art, such applications may be resident in any suitable computer-readable medium and executed on any suitable processor. For example, the devices at environments 10, 20 each may comprise a computer-readable medium such as a random access memory (RAM), coupled to a processor that executes computer-executable program instructions stored in memory. Such processors may comprise a microprocessor, an ASIC, a state machine, or other processor, and can be any of a number of computer processors. Such processors comprise, or may be in communication with a computer-readable medium which stores instructions that, when executed by the processor, cause the processor to perform the steps described herein.

A computer-readable medium may comprise, but is not limited to, an electronic, optical, magnetic, or other storage or transmission device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, or any other medium from which a computer processor can read instructions. A computer-readable medium may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

While the network 100 shown in FIG. 1 may comprise the Internet, in other embodiments, other networks, such as an intranet, or no network may be used. Moreover, methods may operate within a single device. Devices can be connected to a network 100 as shown. Alternative configurations are of course possible. The devices may also comprise a number of external or internal devices such as a mouse, a CD-ROM, DVD, a keyboard, a display, or other input or output devices. Examples of devices are personal computers, digital assistants, personal digital assistants, cellular phones, mobile phones, smart phones, pagers, digital tablets, laptop computers, Internet appliances, other processor-based devices, and television viewing devices. In general, a device may be any type of processor-based platform that operates on any operating system capable of supporting one or more client applications or media content consuming programs.

It should also be recognized that kinematics procedures (both forward and inverse) can be used to facilitate the movement of a hierarchical object (usually by adjusting angles between bones) and provide benefits in a variety of circumstances, including in the context of facilitating the animation of hierarchical object-based elements in computer-based media. “Forward kinematics” refers to moving a parent bone to affect child bone(s) (i.e., affects go down the hierarchy), while “inverse kinematics” refers to moving a child bone to affect parent bone(s) (i.e., up the hierarchy). Inverse kinematics may be used to facilitate the simple control of movement of a hierarchy object (such as an entire arm or an entire person figure), by simply moving one component (such as a hand bone).

1. A computer-implemented method, comprising:
outputting a canvas area for display in a media content development environment, the canvas area comprising a first coordinate space;
outputting a container symbol for display on the canvas area, the container symbol comprising a perimeter defined by sides and a second coordinate space different from the first coordinate space and associated such that movement of the container symbol in the first coordinate space moves the second coordinate space with respect to the first coordinate space, wherein the second coordinate space is an area within the perimeter of the container symbol;
outputting a hierarchical object for display within the second coordinate space of the container symbol, wherein the container symbol is an object for containing other objects and is distinct from the hierarchical object that it contains and wherein positioning of the hierarchical object is specified with respect to the second coordinate space;
receiving a movement for the container symbol with respect to the first coordinate space of the canvas area, wherein the movement of the container symbol moves the second coordinate space;
receiving a movement for the hierarchical object with respect to the second coordinate space, the movement determined using an inverse kinematics procedure; and
creating an animation for a piece of media content, the animation displaying the hierarchical object without displaying the sides of the container symbol, the animation comprising a combined movement of the hierarchical object that comprises a movement of the hierarchical object based on the movement for the container symbol combined with the movement for the hierarchical object received with respect to the second coordinate system.

2. The method of claim 1, wherein the animation comprises a time period over which the animation will be displayed by the piece of media content.

3. The method of claim 2, wherein the animation comprises:
a first snapshot associated with a point during the time period, the first snapshot comprising a position of the hierarchical object on the canvas prior to the movement for the container symbol and the movement for the hierarchical object; and
a second snapshot associated with another point during the time period, the second snapshot comprising a position of the hierarchical object on the canvas after the movement for the container symbol and the movement for the hierarchical object.

4. The method of claim 1, further comprising outputting the movement for the container symbol and the movement for the hierarchical object for simultaneous display as a movement preview prior to creating the animation.

5. The method of claim 1, wherein the container symbol is a rigid body.

6. The method of claim 1, wherein the container symbol is a movie clip, a button, or a graphic.

7. The method of claim 1, wherein the hierarchical object further comprises a rigid body comprising a perimeter, wherein a base of a bone of the hierarchical object is positioned within the rigid body.

8. The method of claim 7 further comprising determining a movement for the rigid body using a rotation of the bone, the movement for the rigid body maintaining a relationship between the bone and the rigid body.

9. The method of claim 1, wherein receiving the movement for the hierarchical object with respect to the second coordinate space comprises:
receiving an identification of an end effector, the end effector comprising a point of the hierarchical object;
receiving an identification of a target location, the target location comprising a point of the second coordinate space; and
determining a changed position of a bone of the hierarchical object by determining a rotation using an inverse kinematics procedure identifying an amount of rotation for a bone.

10. The method of claim 9, wherein the inverse kinematics procedure attempts to position the end effector nearer to the target location.

11. The method of claim 10, wherein the inverse kinematics procedure positions the end effector at the target location.

12. The method of claim 9, wherein a constraint on the hierarchical object limits the rotation of the bone.

13. A computer-implemented method, comprising:
outputting an animation for display as part of a piece of media content, the animation comprising a first movement of an object and a second movement of the object; the first movement of the object defined by a movement of a container symbol within a coordinate space of a canvas area, the second movement of the object defined by a movement of a nested component on a coordinate space associated with the container symbol, wherein the container symbol is a containing object distinct from the object and wherein the coordinate space associated with the container symbol is different from the coordinate space of the canvas area and associated such that movement of the container symbol in the coordinate space of the canvas area moves the coordinate space of the container symbol with respect to the coordinate space of the canvas area;
wherein at least one of the first movement of the object or the second movement of the object is determined using an inverse kinematics procedure.

14. The method of claim 13, wherein the first movement of the object and the second movement of the object occur simultaneously.

15. The method of claim 13, wherein the first movement of the object occurs over a first period of the animation and the second movement of the object occurs over a second period of the animation.

16. The method of claim 15, wherein the first period of the animation and the second period of the animation partially overlap.

17. The method of claim 15, wherein the first period of the animation and the second period of the animation overlap completely.

18. The method of claim 13, wherein object comprises a hierarchical object comprising one or more bones.

19. The method of claim 18, wherein the one or more bones are hidden from display in the animation.

20. The method of claim 13, wherein the container symbol is hidden from display in the animation.

21. A system comprising:
instructions stored on a non-transitory computer readable medium;
a processor operable to execute the instructions that when executed by the processor cause the processor to:
provide an interface for displaying a canvas area comprising a hierarchical object nested in a container symbol in a media content authoring environment and for receiving an identification of an end effector and an identification of a target location, the end effector comprising a point of the hierarchical object, the target location comprising a point of a coordinate space associated with the container symbol; and
determine a combined movement based on a first movement and a second movement, the first movement comprising a movement of the container symbol relative to a canvas area, the second movement comprising a movement of a bone of the hierarchical object, the movement of the bone determined using an inverse kinematics procedure that attempts to position the end effector nearer to the target location, wherein the container symbol is an object for containing other objects and is distinct from the hierarchical object that it contains and wherein the coordinate space associated with the container symbol is different from a coordinate space of the canvas area and associated such that movement of the container symbol in the coordinate space of the canvas area moves the coordinate space of the container symbol with respect to the coordinate space of the canvas area.

22. A non-transitory computer-readable medium on which is encoded program code, the program code comprising:
program code for outputting a canvas area for display in a media content development environment, the canvas area comprising a first coordinate space;
program code for outputting a container symbol for display on the canvas area, the container symbol comprising a perimeter defined by sides and a second coordinate space different from the first coordinate space and associated such that movement of the container symbol in the first coordinate space moves the second coordinate space with respect to the first coordinate space, wherein the second coordinate space is an area within the perimeter of the container symbol;
program code for outputting a hierarchical object for display within the second coordinate space of the container symbol, wherein the container symbol is an object for containing other objects and is distinct from the hierarchical object that it contains and wherein positioning of the hierarchical object is specified with respect to the second coordinate space;
program code for receiving a movement for the container symbol with respect to the first coordinate space of the canvas area, wherein the movement of the container symbol moves the second coordinate space;
program code for receiving a movement for the hierarchical object with respect to the second coordinate space, the movement determined using an inverse kinematics procedure; and
program code for creating an animation for a piece of media content, the animation displaying the hierarchical object without displaying the sides of the container symbol, the animation comprising a combined movement of the hierarchical object that comprises a movement of the hierarchical object based on the movement for the container symbol combined with the movement for the hierarchical object received with respect to the second coordinate system.

23. (canceled)

24. (canceled)
